(19) United States
(12) Patent Application Publication
(10) Pub. No.: US 2020/0156441 A1
(43) Pub. Date: May 21, 2020

(54) VEHICLE DEFOGGING AND DEMISTING SYSTEM

(71) Applicant: FORD GLOBAL TECHNOLOGIES, LLC, Dearborn, MI (US)

(72) Inventors: Mukesh Kumar, Canton, MI (US); Jennifer A. Herr-Rathke, Plymouth, MI (US); Andrew Phillips, Plymouth, MI (US)

(21) Appl. No.: 16/193,438

(22) Filed: Nov. 16, 2018

(51) Int. Cl. B60H 1/00; B60H 1/26

(52) U.S. Cl. CPC B60H 1/00785; B60H 1/267; B60H 1/00864

(57) ABSTRACT

A vehicle defogging and demisting system includes an air handling system, a first humidity sensor adjacent a second row vehicle window, a second humidity sensor adjacent a third row vehicle window and a controller. The controller is configured to defog and demist the second row window in response to a first data stream received from the first humidity sensor and the third row vehicle window in response to a second data stream received from the second humidity sensor. A method of defogging and demisting second and third row vehicle windows of a motor vehicle is also provided.

### TECHNICAL FIELD

This document relates generally to the motor vehicle equipment field and, more particularly, to a new and improved vehicle defogging and demisting system.

### BACKGROUND

Rain or snow from wet shoes may collect on the floor and increase the humidity of the air in the interior of a motor vehicle. This can very easily cause the windows to fog. Also during winter there may be causes for ice buildup on the windows, particularly on the second and third row windows. In autonomous passenger vehicles of the future, this can be particularly problematic as a number of people enter and exit the vehicle over the course of the day.

This document relates to a new and improved vehicle defogging and demisting system having architecture particularly tailored to defog and demist the second and third row windows of a motor vehicle.

### SUMMARY

In accordance with the purposes and benefits as described herein, a new and improved vehicle defogging and demisting system is provided. That vehicle fogging and demisting system comprises: (a) an air handling system, (b) a first humidity sensor adjacent a second row vehicle window, (c) a second humidity sensor adjacent a third row vehicle window and (d) a controller. That controller is configured to defog or demist (1) the second row vehicle window in response to a first data stream received from the first humidity sensor and (2) the third row vehicle window in response to a second data stream received from the second humidity sensor.

More particularly, the air handling system is a heating, ventilating and air conditioning (HVAC) unit, a floor vent and a primary duct extending between the HVAC unit and the floor vent. Still further, the air handling system may include a second row vehicle window vent and a first branch duct extending from the primary duct to the second row vehicle window vent. In addition, the air handling system may include a first door controlling air flow from the primary duct into the first branch duct and a first actuator for displacing the first door between a first closed position and a first opened position.

Still further, the air handling system may include a third row vehicle window vent and a second branch duct extending from the primary duct to the third row vehicle window vent. Further, the air handling system may include a second door controlling the air flow from the primary duct into the second branch duct and a second actuator for displacing the second door between a second closed position and a second opened position.

In one or more embodiments of the vehicle defogging and demisting system, the first humidity sensor may be positioned above a top edge of the second row vehicle window. In one or more embodiments of the vehicle defogging and demisting system, the second humidity sensor may be positioned above an upper most edge of the third row vehicle window.

In one or more embodiments of the vehicle defogging and demisting system, the HVAC unit may be an auxiliary HVAC unit of the motor vehicle.

In one or more embodiments of the vehicle defogging and demisting system, the controller may be configured to open and close the first door by controller controlled operation of the first actuator and open and close the second door by controller controlled operation of the second actuator. Further, in one or more embodiments of the vehicle defogging and demisting system, the system may further include a passenger cabin temperature sensor providing passenger cabin temperature data to the controller.

In accordance with yet another aspect, a method is provided of defogging and demisting a second row vehicle window and a third row vehicle window of a motor vehicle. That method comprises the steps of: (a) sensing, by a first humidity sensor, presence of fog or ice on the second row vehicle window, (b) sensing, by a second humidity sensor, presence of fog or ice on the third row vehicle window and (c) directing, by a controller, conditioned air to defog or deice the second row vehicle window when fog or ice is detected on the second row vehicle window.

Still further, the method may include the step of directing, by the controller, the conditioned air to defog or deice the third row vehicle window when fog or ice is detected on the third row vehicle window.

Still further, the method may include the step of sending humidity data respecting the second row vehicle window from the first humidity sensor to the controller. Further, the method may include the step of sending humidity data respecting the third row vehicle window from the second humidity sensor to the controller.

Still further, the method may include the step of opening a first door for directing conditioned air from the HVAC unit toward the second row vehicle window by a first actuator controlled by the controller. Further, the method may include the step of opening a second door for directing said conditioned air toward the third row vehicle window by a second actuator controlled by the controller.

Still further, the method may include the step of monitoring, by a passenger cabin temperature sensor, a passenger cabin temperature of the motor vehicle. Further, the method may include the step of sending, by the passenger cabin temperature sensor, passenger cabin temperature data to the controller. Still further, the method may include the step of closing by the controller the first door and the second door and directing conditioned air toward a floor vent in response to passenger cabin temperature data received from the passenger cabin temperature sensor.

In the following description, there are shown and described several preferred embodiments of the vehicle defogging and demisting system as well as the related method of defogging and demisting a second row vehicle window and a third row vehicle window of a motor vehicle. As it should be realized, the vehicle defogging and demisting system and method are capable of other, different embodiments and their several details are capable of modification in various, obvious aspects all without departing from the vehicle defogging and demisting system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle defogging and demisting system and related method and together with the description serve to explain certain principles thereof. In the drawing figures:

FIG. 1 is a schematic illustration of a motor vehicle equipped with the vehicle defogging and demisting system.

FIG. 2 is a schematic block diagram of the vehicle defogging and demisting system including the controller, various sensors that provide data to the controller and the controller controlled actuators that open and close the doors for directing conditioned air through the primary duct and the branch ducts of the air handling system.

Reference will now be made in detail to the present preferred embodiments of the vehicle defogging and demisting system, examples of which are illustrated in the accompanying drawing figures.

### DETAILED DESCRIPTION

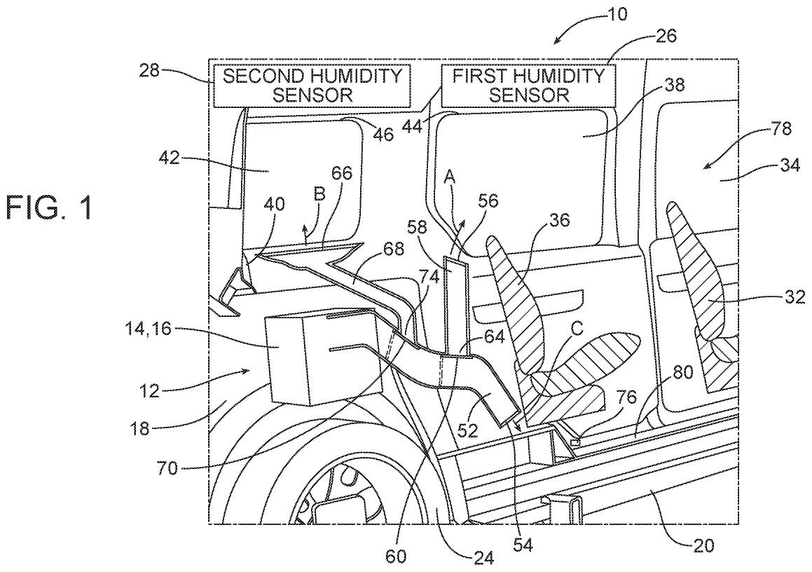

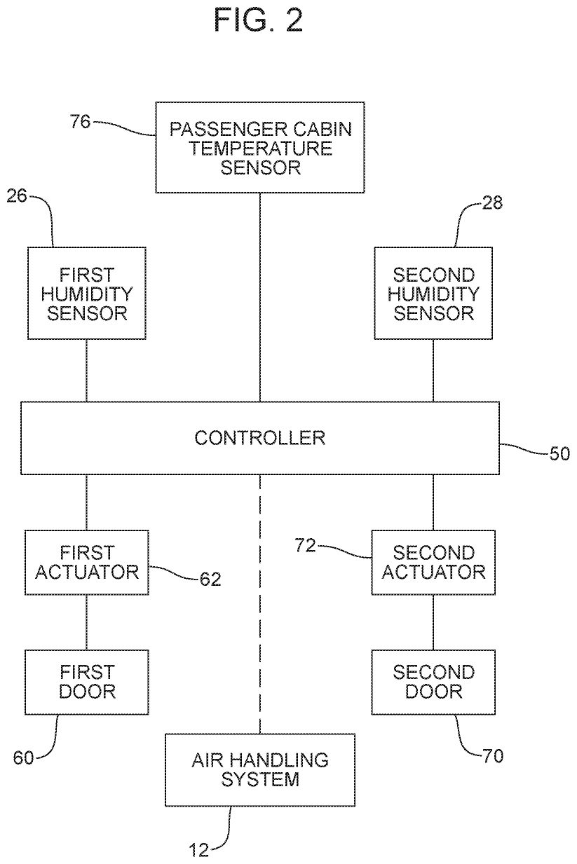

Reference is now made to FIGS. 1 and 2 illustrating the new and improved vehicle defogging and demisting system 10. That vehicle defogging and demisting system 10 includes an air handling system 12 which may comprise a heating, ventilating and air conditioning (HVAC) unit 14. In one particularly useful embodiment the air handling system 12 comprises an auxiliary HVAC unit 16 of a type known in the art as schematically illustrated in FIG. 1.

As illustrated in FIG. 1, the auxiliary HVAC unit 16 may be carried within the sidewall 18 of the motor vehicle 20 above the rear wheel 24. The vehicle defogging and demisting system 10 may also include a first humidity sensor 26 and a second humidity sensor 28.

As illustrated in FIG. 1, the motor vehicle 20 includes a first row seat 32 by a first row window 34, a second row seat 36 by a second row window 38 and a third row seat 40 by a third row window 42. In the illustrated embodiment, the first humidity sensor 26 is carried in the motor vehicle 20 adjacent the second row window 38. The second humidity sensor 28 is carried in the motor vehicle 20 adjacent the third row window 42. More particularly, in the illustrated embodiment, the first humidity sensor 26 is positioned above a top edge 44 of the second row window 38. The second humidity sensor 28 is positioned above an upper most or top edge 46 of the third row window 42.

The first humidity sensor 26 and second humidity sensor 28 may comprise any form of sensor or monitoring device capable of monitoring for the presence of fog or ice on the associated window 38, 42.

The vehicle defogging and demisting system 10 also includes a controller 50. See FIG. 2. The controller 50 may comprise a computing device such as a dedicated microprocessor or an electronic control unit (ECU) operating in accordance with instructions from appropriate control software. Thus, as should be appreciated, the controller 50 may include one or more processors, one or more memories and one or more network interfaces all in communication with each other over one or more communication buses of the motor vehicle. In some embodiments, the controller may comprise a body control module (BCM). Such a BCM may be of a type known in the art and adapted to perform a number of interior body electrically based functions including, for example, interior locking, remote key entry, interior lighting, exterior lighting, windshield wiper control and the like. In some embodiments the BCM may also function to control entertainment functions (e.g. radio, CD player) and communications such as telephone and internet communications over a wireless network. Further, in some embodiments the BCM may be connected by a communication bus (not shown) to other control modules that provide one or more of these additional functions.

The controller 50 may be configured to defog or demist (a) the second row vehicle window 38 in response to a first data stream received from the first humidity sensor 26 and (b) the third row vehicle window 42 in response to a second data stream received from the second humidity sensor 28.

Toward this end, the air handling system 12 may include a primary duct 52 extending between the HVAC unit 14 and a floor vent 54. See FIG. 1. As further illustrated in FIG. 1, the air handling system 12 may also include a second row vehicle window vent 56 and a first branch duct 58 extending from the primary duct 52 to the second row vehicle window vent.

Still further, the air handling system 12 may include a first door 60 controlling air flow from the primary duct 52 into the first branch duct 58 and a first actuator 62 for displacing the first door between a first closed position closing the first port 64 and thereby preventing air to pass from the primary duct to the first branch duct and a first opened position opening the first port and allowing air to pass from the primary duct to the first branch duct. Note closed position illustrated in full line and full open position illustrated in phantom line in FIG. 1.

As further illustrated in FIG. 1, the air handling system 12 may also include a third row vehicle window vent 66 and a second branch duct 68 extending from the primary duct 52 to the third row vehicle window vent.

Still further, the air handling system 12 may include a second door 70 controlling air flow from the primary duct 52 into the second branch duct and a second actuator 72 for displacing the second door between a second closed position closing the second port 74 in the primary duct and preventing air from passing into the second branch duct and a second opened position allowing air to pass through the second port from the primary duct into the second branch duct 68. Note closed position illustrated in full line and full open position illustrated in phantom line in FIG. 1.

The controller 50 may also be configured to open and close the first door 60 by controller controlled operation of the first actuator 62 and open and close the second door 70 by controller controlled operation of the second actuator 72. See FIGS. 1 and 2.

As should also be appreciated, the vehicle defogging and demisting system 10 may include a passenger cabin temperature sensor 76 for monitoring the temperature of the passenger cabin and providing passenger cabin temperature data to the controller 50. The passenger cabin temperature sensor 76 may be mounted substantially anywhere within the passenger cabin 78 of the motor vehicle 20. In the illustrated embodiment, the passenger cabin temperature sensor 76 is mounted below the second row seat 36 adjacent the floor 80. In other embodiments, it could be mounted adjacent the floor between the second row and third row seats 36, 40.

Consistent with the above description, the vehicle defogging and demisting system 10 provides a new and improved method of defogging and demisting a second row window 38 and a third row window 42 of a motor vehicle 20. That method may be broadly described as comprising the steps of: (a) sensing, by the first humidity sensor 26, the presence of fog or ice on the second row vehicle window 38, (b) sensing, by a second humidity sensor 28, the presence of fog or ice on the third row vehicle window 42 and (c) directing, by the controller 50, conditioned air to defog or deice the second row vehicle window 38 when fog or ice is detected on the second row vehicle window. More particularly, when the controller 50 receives a first data stream from the first humidity sensor 26 indicating that the presence of fog or ice has been detected on the second row vehicle window 38, the controller 50 sends a control signal to the first actuator 62 causing the first door 60 to be displaced from the fully closed position illustrated in full line in FIG. 1 into an open position including, but not necessarily limited to the fully opened position illustrated in phantom line in FIG. 1. Once the first door 60 is opened, the first port 64 is opened allowing conditioned air to flow from the auxiliary HVAC unit 16 through the primary duct 52, the first port 64 and the first branch duct 58 to the second row vehicle window vent 56. The second row vehicle window vent 56 then directs that conditioned air onto the inner surface of the second row vehicle window 38 (note action arrows A) so as to defog and demist the second row vehicle window.

The method may also include the step of directing, by the controller 50, the conditioned air to defog or deice the third row vehicle window 42 when fog or ice is detected by the second humidity sensor 28 on the third row vehicle window. More particularly, when the second humidity sensor 28 sends a second data stream indicative of the presence of fog or ice on the third row window 42, the controller 50 responds by sending a control signal to the second actuator 72 causing the second door 70 to be displaced from the closed position illustrated in full line in FIG. 1 to an open position up to and including the fully opened position illustrated in phantom line in FIG. 1. As the second door 70 is opened, conditioned air passes from the auxiliary HVAC unit 16 through the primary duct 52, the second port 74 and the second branch duct 68 to the third row vehicle window vent 66. The third row vehicle window vent 66 directs that conditioned air onto the inner surface of the third row window 42 (note action arrow B) so as to defog or deice that window as desired.

Here it should be appreciated that the controller 50 may be configured to partially or fully open either one or both of the doors 60, 70 in order to direct conditioned air to the appropriate window vent 56, 66 to defog or demist either the second row window 38 or the third row window 42 as required depending upon the detection of fog or ice on those windows by the first and second humidity sensors 26, 28.

The method may also include the steps of (a) monitoring, by the passenger cabin temperature sensor 76, the passenger cabin temperature of the motor vehicle and (b) sending, by the passenger cabin temperature sensor, passenger cabin temperature data to the controller 50.

In the event the passenger cabin temperature sensor 76 located near the floor 80 provides data to the controller 50 indicating that the passenger cabin temperature has dropped below a comfort threshold temperature, the controller 50 may be configured to close both of the doors 60, 70 so that air passes from the auxiliary HVAC unit 16 through the primary duct 52 directly to the floor vent 54 at the distal end of the primary duct. That conditioned air is then directed in the direction of action arrows C along the floor 80 of the motor vehicle to provide a bottom up heating effect for the occupants of the passenger compartment or cabin 78 of the motor vehicle 20. Toward this end, the controller 50 sends an appropriate control signal to the first actuator 62 to close the first door 60 and the second actuator 72 to close the second door 70.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A vehicle defogging and demisting system, comprising:
an air handling system;
a first humidity sensor adjacent a second row vehicle window;
a second humidity sensor adjacent a third row vehicle window; and
a controller configured to defog or demist (a) said second row vehicle window in response to a first data stream received from said first humidity sensor and (b) said third row vehicle window in response to a second data stream received from said second humidity sensor.

2. The vehicle defogging and demisting system of claim 1, wherein said air handling system is a heating, ventilation and air conditioning (HVAC) unit, a floor vent and a primary duct extending between said HVAC unit and said floor vent.

3. The vehicle defogging and demisting system of claim 2, wherein said air handling system includes a second row vehicle window vent and a first branch duct extending from said primary duct to said second row vehicle window vent.

4. The vehicle defogging and demisting system of claim 3, wherein said air handling system includes a first door controlling air flow from said primary duct into said first branch duct and a first actuator for displacing said first door between a first closed position and a first opened position.

5. The vehicle defogging and demisting system of claim 4, wherein said air handling system includes a third row vehicle window vent and a second branch duct extending from said primary duct to said third row vehicle window vent.

6. The vehicle defogging and demisting system of claim 5, wherein said air handling system includes a second door controlling said air flow from said primary duct into said second branch duct and a second actuator for displacing said second door between a second closed position and a second opened position.

7. The vehicle defogging and demisting system of claim 6, wherein said first humidity sensor is positioned above a top edge of said second row vehicle window.

8. The vehicle defogging and demisting system of claim 7, wherein said second humidity sensor is positioned above an uppermost edge of the third row vehicle window.

9. The vehicle defogging and demisting system of claim 8, wherein said HVAC unit is an auxiliary HVAC unit.

10. The vehicle defogging and demisting system of claim 9, wherein said controller is configured to open and close said first door by controller controlled operation of said first actuator and open and close said second door by controller controlled operation of said second actuator.

11. The vehicle defogging and demisting system of claim 10, further including a passenger cabin temperature sensor providing passenger cabin temperature data to said controller.

12. A method of defogging and demisting a second row vehicle window and a third row vehicle window of a motor vehicle, comprising:
sensing, by a first humidity sensor, presence of fog or ice on said second row vehicle window;
sensing, by a second humidity sensor, presence of said fog or said ice on said third row vehicle window; and
directing, by a controller, conditioned air to defog or deice said second row vehicle window when fog or ice is detected on said second row vehicle window.

13. The method of claim 12, further including directing, by said controller, said conditioned air to defog or deice said third row vehicle window when fog or ice is detected on said third row vehicle window.

14. The method of claim 13, further including sending humidity data respecting said second row vehicle window from said first humidity sensor to said controller.

15. The method of claim 14, further including sending humidity data respecting said third row vehicle window from said second humidity sensor to said controller.

16. The method of claim 15, further including opening, by the controller, a first door for directing conditioned air toward said second row vehicle window by a first actuator controlled by said controller.

17. The method of claim 16, further including opening, by the controller, a second door for directing said conditioned air toward said third row vehicle window by a second actuator controlled by said controller.

18. The method of claim 17, including monitoring, by a passenger cabin temperature sensor, a passenger cabin temperature of said motor vehicle.

19. The method of claim 18, including sending, by said passenger cabin temperature sensor, passenger cabin temperature data to said controller.

20. The method of claim 19, including closing, by the controller, said first door and said second door and directing conditioned air toward a floor vent in response to data received from said passenger cabin temperature sensor.
